(19) United States
(12) Patent Application Publication
(10) Pub. No.: US 2006/0035201 A1
(43) Pub. Date: Feb. 16, 2006

(54) Device for improving performance and improving assessment in a combat training center

(76) Inventors: Holger Böttcher, Uetersen (DE); Ernst Christians, Henstedt-Ulzburg (DE); Marco Dickenhausen, Seeth-Ekholt (DE); Wilfried Goda, Hamburg (DE); Maik Hölzel, Hamburg (DE); Ralf Kauffeldt, Hamburg (DE); Jan Marek, Elmshorn (DE); Frank Thelen, Hamburg (DE); Ingo Wittwer, Pinneberg (DE)

Correspondence Address: WILLIAM COLLARD;COLLARD & ROE, P.C., 1077 NORTHERN BOULEVARD, ROSLYN, NY, 11576, US

(21) Appl. No.: 11/201,899

(22) Filed: Aug. 11, 2005

(30) Foreign Application Priority Data
Aug. 12, 2004 (DE) 10 2004 039 336.2

(51) Int. Cl. A63B 69/00; G09B 19/00

(52) U.S. Cl. 434/247

(57) ABSTRACT

A device for improving performance and improving assessment in a combat training center includes light shot simulators with weapon-linked transmitters and/or transceivers as active equipment and personal or passive equipment of exercise participants, with light-signal receivers and decoding electronics as well as GPS equipment assigned to a person and/or exercise device, for a determination of position, as well as radio equipment of the persons and/or the device, for bi-directional communication with a central administration. The light-signal receivers are equipped for additional detection of the position of the exercise participants in rooms/buildings and vehicles, by means of the reception of signals from light-optic angle transmitters.

### CROSS REFERENCE TO RELATED APPLICATIONS

Applicants claim priority under 35 U.S.C. §119 of German Application No. 10 2004 039 336.2 filed Aug. 12, 2004.

### FIELD OF THE INVENTION

The present invention relates to a device for improving performance and improving assessment in a combat training center, with light-shot simulators with weapon-linked transmitters and/or transceivers as active equipment and personal or passive equipment of exercise participants, with light-signal receivers and decoding electronics as well as global positioning system (GPS) equipment assigned to a person and/or exercise device, for a determination of position, as well as radio equipment of the persons and/or the device, for bi-directional communication with a central administration.

### THE PRIOR ART

The best protection of a soldier and his or her leaders is good training in the weapons and in the field. Nowadays, realistic training in urban and house-to-house combat has become absolutely necessary.

For many years, laser gun simulators using infrared lasers have proven themselves as an excellent means of training. Such simulators are excellent both for short-range shooting training and for combat training in the field and in urban spaces. They allow the use of original weapons and weapon systems without using the expensive ammunition. In its place, the actions of attacker and target are measured and assessed by means of a weapon-linked laser and other sensors, and thus recognized with great accuracy as a hit or a miss. In this connection, the characteristics of the ammunition being used are taken into consideration, as is the ability to wound the target in the hit region.

As a rule, the simulators consist of an active part that is connected with the weapon. In the case of one-way systems, the systems are made up mainly of a laser transmitter. In the case of two-way systems, the systems are made up mainly of a laser transceiver that sends coded laser pulses to the target and also receives them back. So that the soldier or the vehicle can in turn be hit, the simulator furthermore consists of a passive part that in most instances consists of the components infrared receiver with signal amplifiers and reflectors, central computer for decoding the light signals and for control and calculating the results, as well as display elements for representing the signatures of the-shot (sound, flash, and smoke) or of the state of having been hit (colored smoke).

Nowadays, there are combat training centers for carrying out a complex exercise involving several hundred participants (soldiers and vehicles), for example for a battle of the linked weapons. These systems are made up of an administrative center for supervising the exercise, for recording the data of the combat participants, using data technology, and for the assessment that is required after the exercise. The systems also include a number of field components that mainly allow the bi-directional radio technology exchange, which proceeds automatically, in part, between the exercise participants and the administrative center. Depending on the design of the system and the definition of the manufacturer, the following information is transmitted for central assessment: location (local coordinates), status (virtual ammunition supply, charging status of the batteries, state of having been hit, partial wounding or damage, shots fired, hits achieved), and activity of each exercise participant.

By means of knowing the position of each combat participant, the exercise administration can additionally convincingly simulate the effect of indirect fire or of mines or mine blocks, particularly if hazards are available that simulate the effects of indirect weapons in the exercise field, without prior activities. In other words, the effects are simulated without a “prior warning” to the combat participants. These simulations in turn are necessary so that the soldiers can gain comprehensive deployment experience within the scope of the training, without simulation-specific adulteration and without risk to their health or destruction of the material, such as equipment, apparatus and supplies.

In order to locate the individual exercise participants in the field, Differential-GPS (D-GPS) positioning is generally used nowadays. This system makes it possible for the exercise administration in the administrative center to gain an accurate picture of the situation in the battlefield.

In practice, however, there is a need for a number of improvements to increase realism and to improve the determination of the position of persons and material.

### SUMMARY OF THE INVENTION

It is an object of the present invention, therefore, to provide a device in a combat training center that allows an improvement in performance and an improvement of the assessment, in that equipment that is already available is supplemented in a simple and inexpensive manner.

These and other objects are accomplished according to the invention, by equipping the light-signal receivers of the personal or passive equipment of exercise participants for additional detection of the position of the exercise participants in rooms/buildings and vehicles by means of the reception of signals from light-optic angle transmitters. Advantageous further embodiments of the present invention are discussed below.

According to the invention, an improved device is provided with which known training systems having equipment already available for combat exercises (such as, in particular, light-signal receivers, including amplification and decoding electronics, navigation equipment (GPS), and communications devices or bi-directional data exchange with transponders and the central station) can be supplemented and equipped with devices and revised software, so that additional functions are possible. These functions include, among others:

Determining the precise position of exercise participants in the field, even if GPS signals cannot be detected (under cover, shielded by rocks, etc., dense forest);

Ability to recognize the effects of simulated indirect fire (flash, smoke) at the correct location, i.e. at the simulated hit point of the projectiles;

Transfer of the “effect” of simulated indirect fire to the surrounding combat participants, taking the general conditions into consideration (weapon, local coordinates, protection);

Spatially accurate determination of the position of exercise participants in buildings;

Spatially accurate ensuring of the transfer of effect on exercise participants in buildings;

Correct simulation of the effect of bombardment on building facades, taking the general conditions into consideration (distance of attackers, type of projectile, impact angle, etc.);

Determining the position of exercise participants in buildings with great accuracy (typically accurate to a decimeter);

Transfer of effect on exercise participants, with great accuracy (typically accurate to a decimeter), in order to also be able to simulate the effect of penetrating shots (façade, wall, door, window), for example.

The additional equipment effort and expense required for use of the invention, and therefore the additional costs, are insignificant. Additional equipment items on the combat participant are not necessary, nor is an additional demand for electrical power. Such additional equipment and electrical-power demand are unnecessary because the device according to the invention can additionally utilize modules of the simulator that are fundamentally already available on the combat participant, for the desired and required performance characteristics.

The equipment is structured so that the radio signal receivers originally present only for receiving radio protocols can additionally also receive local coordinates from directional transmitters positioned in the exercise field, and measured in. In the case of an infantry soldier, the equipment is his or her personal or body equipment. From these signals, the electronics of the bodys equipment calculate the local positions of the exercise participants in those field segments in which GPS signals cannot be received, or cannot be received sufficiently well, using known algorithms.

The same method is also used for spatially accurate positioning of soldiers in buildings, or in the assignment of soldiers to combat vehicles. For this purpose, a directional transmitter having an adapted transmission power is preferably used per room and per vehicle. Suitable directional transmitters are multi-functional devices, preferably powered by a battery or rechargeable battery which can additionally be used also for light-optic or pyrotechnic simulation of the impact effects of artillery munitions in the field. During the simulation of indirect fire, the directional transmitter can also send codes, by radio, which signal artillery fire to the exercise participant, in the immediate vicinity. If applicable, the codes can result in simulated incapacitation of the soldier.

In buildings, every room in which the position of exercise participants is supposed to be determined with great accuracy is preferably equipped with at least two angle transmitters on a laser basis. Every transmitter, preferably mounted in corners of a room, transmits coded light wave signals with its light beams, which are formed in such a manner and are deflected in such a manner that in their totality, they have illuminated every point in the room at least once after a single deflection process. The coded signals of the light beams contain their current angle position and the type of room. The body equipment illuminated with the light beams detects these data, using the light signal receivers that are already present for simulation operation. The electronics of the body equipment decode the signals and calculate the position of the exercise participant in the room.

For more demanding requirements, the light beam can be additionally divided, preferably vertically, with regard to the code that is being sent. In addition to determining the local position, the position of the combat participant (lying down, kneeling, standing) can thereby be determined on the basis of the body equipment.

In another preferred embodiment, the angle transmitter is structured so that a distance measurement is connected with each segmented “illumination” of the monitoring field. For this purpose, the light beam transmits its own identification (ID), the angle position that has been reached, and the distance between the transmitter and the participant. The combat participant can thereupon calculate and report his position in the room.

Using these angle transmitters, the effect of a projectile that penetrates the façade of the building in the simulation, on the rooms and building areas located in the projectile path, can also be transferred. For this purpose, the transmitters send hit code data in accordance with the projectile path, which are detected and evaluated by the body equipment of the soldiers present there.

The simulated transfer of effect is also possible in that the coordinates of the projectile path (room entry point, volume, room exit point) are transmitted into the room, in each instance. For example, the coordinates may be transmitted with radio transmitters additionally installed in the transmitters. If the coordinates of the projectile path and the position of the combat participants coincide, the equipment of the combat participants in question is then deactivated. Of course the intensity of the effect, in the final analysis, therefore, the volume of the effect channel, is derived from the general conditions (type of projectile, etc.).

In order to be able to determine the effect of simulated projectiles on buildings, in other words on façades, including windows and doors, the buildings included in the exercise are preferably instrumented. The façades are marked with reflectors and direction-resolving light signal receivers, in a fixed raster of 2 m×2 m, for example. The reflectors are preferably designed (wavelength-differentiating reflection) so that the active simulator can support the assessment of the defense situation, taking into consideration fields of effect and other information.

Even without special measures, the laser pulses are detected by the simulator of the attacking system, on the façade, in the predetermined raster, with a receiver combination. For example, the laser pulses may be detected with a left receiver from the range of 20 degrees to 80 degrees, with a central receiver from the range of 60 degrees to 120 degrees, and with a right receiver from the range of 100 degrees to 160 degrees. As an example, the data would be as follows: reference: façade or wall; direct bombardment: 90 degrees. By means of logical signal linking in combination with the façade electronics, the impact point and defense direction can be determined. For the façade or for the inner building wall, the required data such as distance of attackers, projectile type, impact point, and impact angle of the simulated projectile, as well as the defined properties of the building wall, are therefore available for calculating the effect. Doors, windows, and prepared passage openings can be opened by means of actuators. The bombardment situation on the face can be signaled by light optics and/or pyrotechnics. For the transfer of effect to rooms through which the projectile has passed, if applicable, the projectile effect channel behind the bombarded façade or behind the bombarded wall can be calculated with the available data. Using the light-optic angle transmitters, which already allow precise positioning of the combat participants, the projectile effect channel can now be illuminated at the proper time, using a coded light beam. The simulated projectile effect is thereby accurately transferred to those combat participants that would have been hit by a real projectile.

The determination of the simulated projectile impact angle is also possible as follows, in another embodiment of the invention: Every combat participant knows his or her current position on the battlefield, by means of (D)GPS or directional transmitter assessment. This position is transmitted to the target, particularly the building façade, with the simulation-specific data per simulation laser. The local coordinates of the façade are present in the assessment electronics for assessing the façade bombardment. Therefore the simulated projectile impact angle and thereby the basic information for passing on the effect can be calculated in this way, as well, in a simple manner. With this embodiment, it is possible to do without the use of angle-sensitive light-signal receivers.

Using the additional instrumentation according to the invention and the evaluation software required for this purpose, it is possible to configure combat training in useful manner, using light shot simulators, in comprehensive manner, for field deployment, by means of the use of position signals from directional transmitters. Such field deployment includes deployment under cover and in forest, or in other words, in areas with interrupted or restricted reception of GPS signals. The directional transmitters serve, at the same time, for signaling the impact of indirect weapons (by means of light signals and/or pyrotechnics), as well as for a radio technology transfer of effect for indirect weapons in the immediate vicinity.

In order to utilize light shot simulators in urban areas (house-to-house and urban combat), all of the façades and walls that must be fought against in the exercise are equipped with angle-selective light-signal receivers, flashes and/or pyrotechnics and electronics, preferably in a raster of 2 m×2 m, for example. The façade/wall electronics are programmed so that they take into consideration the individual situation (doors, windows, wall material, prior damage, etc.). During the simulated battle, calculations are furthermore carried out for the façade or wall that might have been penetrated, to determine the projectile channel behind the façade or wall. By means of the at least two (2) angle transmitters installed in all of the instrumented rooms, the simulated effect of the projectile that penetrates the wall is transferred to the combat participants who are located in the vicinity of the projectile channel. In this connection, the angle transmitters also serve for determining the position of the combat participants in the room, accurate to a decimeter, for the central exercise administration and for assessment of the simulated combat.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 2A is a front view of a building facade provided with instruments;

FIG. 2B is an enlarged view of reflectors and receivers;

FIG. 2C is a top view of a building facade with a room located behind it;

FIG. 3 shows an angle transmitter and beam cross-sections.

### DETAILED DESCRIPTION OF PREFERRED EMBODIMENTS

Turning now in detail to the drawings, FIG. 1 shows a weapon 1 that contains a laser transceiver 2. When a target is hit, a pyrotechnic signature representation is triggered on the display or effect field 3. Passive light-shot simulators that are assigned to persons or vehicles are made up of a passive device or unit 4 that contains reflectors, light-signal receivers, decoding electronics, a radio transponder, a hit signature, a GPS receiver, and a power supply.

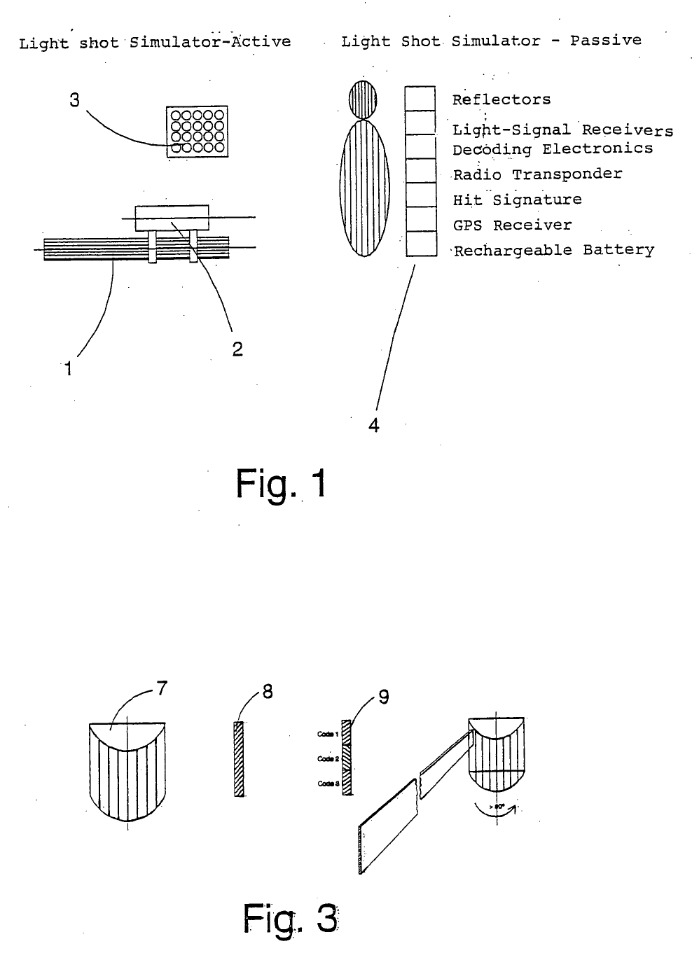

FIG. 2A shows a schematic of an instrumented building façade that is equipped with sensors 10 for detailing and signalling laser pulses of exercise participants in a raster. As shown in FIG. 2A, the building façade is provided, over a large area, with reflectors 11 and receivers 12, in a raster. The reflectors and receivers, which are shown in an enlarged view in FIG. 2B, can detect both the impact region of a shot an its impact angle, in the case of a cluster configuration of receiver 12 with lateral reception surfaces 14 and a central reception surface 15. In this way, it is possible to also determine the exit region and angle, assuming that the wall has been penetrated, so that the assumed further shot progression in the interior of the building can be determined. FIG. 2C shows a top view of the wall and the room located behind it, in which two angle transmitters 5 and 6 determine the position of an object 13 that is located in the shot line from the impact location.

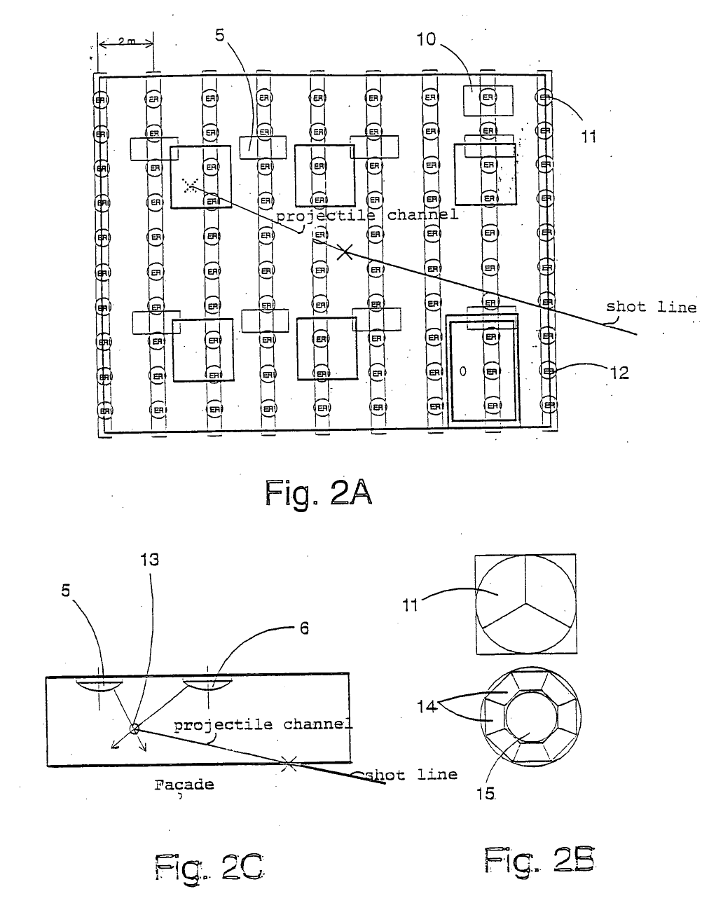

FIG. 3, shows an angle transmitter 1 that can be used, which transmits a vertically extended narrow light beam 8 and sweeps a room angle with rapid repetition. The light beam 9 can also be configured to be segmented vertically, in order to allow a height determination of objects, in addition.

The light-optic angle transmitters may transmit a light beam that is coded and extended in a first direction, in each instance, which sweeps a room angle in a second direction, perpendicular to that, and transmits at least one coded individual ID and the current deflective position. The room angle may be greater than 90 degrees and the deflection velocity is typically greater than 100 degrees/second.

Non-moving targets, such as building façades and walls, and moving targets, such as vehicles, may be equipped with a raster of sensors for detecting and signaling laser pulses of exercise participants.

The effect of a projectile on the non-moving or moving target can be calculated and simulated from stored geometrical data of the non-moving or moving targets and from the general conditions of a hit on the target, such as attacker, ammunition, impact angle, and attacker distance.

Although only a few embodiments of the present invention have been shown and described, it is to be understood that many changes and modifications may be made thereunto without departing from the spirit and scope of the invention as defined in the appended claims.

What is claimed is:

1. A simulator device for improving performance and improving assessment in a combat training center comprising:
(a) active equipment for exercise participants comprising a plurality of light-shot simulators with weapon-linked transmitters or receivers; and
(b) personal or passive equipment for exercise participants comprising a plurality of light-signal receivers, decoding electronics, GPS equipment assigned to an exercise participant or an exercise device for determination of a position, and radio equipment assigned to the exercise participant or the exercise device for bi-directional communication with an administrative center;
wherein said light-signal receivers are equipped to additionally detect position of the exercise participant in a room, Building or vehicle by receiving signals from a plurality or light-optic angle transmitters.

2. The device according to claim 1, wherein each of said light-optic angle transmitters transmits a respective light beam that is coded and extended in a first direction, said light beam sweeping a room angle in a second direction perpendicular to said first direction, and transmitting at least one coded individual identification and a current deflection position.

3. The device according to claim 2, wherein the room angle is greater than 90 degrees and the light beam is deflected at a deflection velocity greater than 100 degrees/second.

4. The device according to claim 2, wherein the light beam determines a distance from the angle transmitter to the personal or passive equipment.

5. The device according lo claim 2, wherein the light beam of the angle transmitter is segmented into a plurality of partial beams coded independently of one another, in the first direction.

6. The device according to claim 1, wherein the exercise participants in an exercise field have existing sensors for determining position of the exercise participants by receiving radio signals from a plurality of directional transmitters measured into the field.

7. The device according to claim 1, wherein local coordinates of exercise participants are determined or calculated from the position of the exercise participants and sent to the administrative center in a data format that corresponds to the data format used by a GPS or directional radio transmitter in a training center.

8. The device according to claim 1, wherein non-moving targets or moving targets are equipped with sensors in a raster for detecting and signaling laser pulses of exercise participants.

9. The device according to claim 3, wherein each sensor comprises a plurality of reflectors and light-signal receivers per raster point for allowing an angle-sensitive assessment of attacker direction by means of geometrical segmenting.

10. The device according to claim 8, wherein the non-moving or moving targets are marked with reflector clusters having filters for reflecting or non-reflecting light waves of a certain wavelength.

11. The device according to claim 10, wherein each exercise participant has a simulation laser for transmitting current position of the exercise participant to the non-moving or moving target.

12. The device according to claim 11, wherein the non-moving or moving target have sensor electronics calculating for a projectile impact angle from an attacker position and local coordinates of an impact point.

13. The device according to claim 9, wherein an effect of a projectile on the non-moving or moving target can be calculated and simulated from stored geometrical data of the non-moving or moving targets and from general conditions of a hit on the target.

14. The device according to claim 13, wherein determined data from the effect of the projectile can be used to calculate a possible continuation of a path of the projectile behind a penetrated wall.

15. The device according to claim 13, wherein an effect code is transmitted in a room or a building when a simulated projectile penetrates the room or building, using the light-optic angle transmitters at an appropriate time and location.

16. The device according to claim 15, wherein the effect code deactivates the light-shot simulator when façade or wall penetration is calculated.

17. The device according to claim 15, wherein the effect code deactivates the simulator device when a façade or wall penetration is calculated.

18. The device according to claim 1, wherein projectile path coordinates corresponding to wall exit, volume, and wall entry are transmitted in a building by means of radio signals.

19. The device according to claim 18, wherein the projectile path coordinates transmitted by radio are compared with a position of an exercise participant and in case of agreement, the equipment of the exercise participant is deactivated.
